(19) United States
(12) Patent Application Publication
(10) Pub. No.: US 2026/0301258 A1
(43) Pub. Date: Oct. 1, 2026

(54) MAINTAINING ITEM IDENTITY IN TRANSLATED IMAGES

(71) Applicant: Amazon Technologies, Inc., Seattle, WA (US)

(72) Inventors: Michael Opitz, Berlin (DE); Sujith Gunjur Umapathy, Berlin (DE); Nikhil Garg, Berlin (DE); Angel Noe Martinez Gonzalez, Berlin (DE); Nadine Behrmann, Muenchen (DE); Epameinondas Antonakos, Berlin (DE)

(21) Appl. No.: 19/093,115

(22) Filed: Mar. 27, 2025

(51) Int. Cl. G06T 11/60; G06F 40/58; G06T 11/00; G06V 30/148

(52) U.S. Cl. CPC G06T 11/60; G06F 40/58; G06T 11/10; G06V 30/148

(57) ABSTRACT

Systems and methods are provided for selectively translating text present in an infographic image describing an item. Text is identified within an image and classified as to-be-translated or not-to-be-translated text. The to-be-translated text is removed from the image to create and empty image. The to-be translated text is translated from a first language to a second language. The layout of the empty image is modified based on the translated text. The translated text is superimposed on the modified empty image.

### BACKGROUND

Systems have been developed to translate text from one language to another to allow speakers of different languages to interact with the same items. Users may enter text in a first language, select a second language for translating the text, and receive an output of the same text in the second language. Current systems may use a dictionary or mapping of terms in different languages to perform the translation.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 is a diagram showing an example computing environment in which features of the present disclosure may be implemented, according to some embodiments.

FIG. 2A illustrates an example item image, according to some embodiments.

FIG. 2B illustrates an example annotated item image, according to some embodiments.

FIG. 2C illustrates an example visual segmentation map overlayed on an item image, according to some embodiments.

FIG. 2D illustrates example visual segments overlayed on an item image, according to some embodiments.

FIG. 2E illustrates an example of an empty image generated through text erasing of an item image, according to some embodiments.

FIG. 2F illustrates a rendered image, according to some embodiments.

FIG. 3 illustrates an example routine for localizing images, according to some embodiments.

FIG. 4 is a block diagram of an illustrative computing system configured to provide text localization, according to some embodiments.

### DETAILED DESCRIPTION

The present disclosure relates to maintaining item identity during image localization, including maintaining the appearance of text embedded within an image that is located on an item, brand logo, and/or certification and translating text embedded within the image that is not located on an item, brand logo, and/or certification.

A conventional network-accessible marketplace may serve item pages that may each include images and/or text describing an item that can be acquired via the network-accessible marketplace. High quality and accurate imagery in network-accessible marketplaces enables users to make accurate and faster item acquisition decisions. Users may prefer to see key item information in images and can struggle to find such information on text-heavy item pages. Many third party entities that use a conventional network-accessible marketplace to offer items to users for acquisition use infographic images that combine item shots, icons, and/or embedded text (e.g., text superimposed onto an image or otherwise placed on a portion of the image) to keep users attention and succinctly highlight item features.

In many of these infographic images, the embedded text is written in a first language (e.g., English). The embedded text may be written in the first language even in item pages served by conventional network-accessible marketplaces to locations where the first language is not the default or primary language. In such cases, users may look for other items or navigate away from the conventional network-accessible marketplace where infographic images do not match the primary or default language of the location to which the item pages are served. On the other hand, users may be more likely to acquire an item or remain at a network-accessible marketplace if infographic images are automatically translated to the primary or default language of the location to which the item pages are served.

Infographic images often include item shots, icons (including brand names, logos, or other certifications), and/or embedded text. In some cases, the item shots themselves may include text. As an illustrative example, an infographic image may include an item shot of a box of cereal. The box of cereal may include text, such as the name of the cereal and information about the cereal (e.g., nutritional information like the amount of fiber provided, the flavors of the cereal, etc.). To help ensure item fidelity, such that consumers understand that they have received the same item displayed in the infographic image, it can be advantageous during localization to leave text associated with items, brand names, logos, or other certifications (also referred to herein as “item-associated text”), untranslated, while translating the additional embedded text included in the infographic image.

Current translation systems fail to differentiate between embedded text and item-associated text and simply translate all detected text. This can lead to consumers expecting an item with translated text and result in consumer dissatisfaction or confusion when the item does not arrive as advertised. Additionally, current translation systems poorly maintain original font properties and text layout, resulting in lower aesthetic quality in translated images as compared to original untranslated images.

Some aspects of the present disclosure address some or all of the issues noted above, among others, by detecting, classifying, and translating text within an image as well as erasing existing text from the image, modifying the text layout for the translated text, and rendering the image with the translated text. This enables localizing imagery associated with an item, while maintaining item fidelity within the image.

In some embodiments, an image localization system described herein can detect text within an image, such as by using Optical Character Recognition (OCR). The detected text can be classified as to-be-translated (also referred to herein as TBT text) or not-to-be-translated (also referred to herein as DNT text). In some embodiments, the image localization system may identify a list of bounding boxes along with associated text.

In some embodiments, the image localization system may utilize a classification model, such as a multi-modal machine learning model, to classify text. The multi-modal machine learning model may combine visual and textual features, such as by extracting image features associated with the bounding boxes as well as textual features based on the associated text. The image localization system may concatenate the visual and textual features into a single feature vector which can be used to classify text as TBT text or DNT text. For example, in an infographic image that includes an item, such as a cereal box with text on it, as well as embedded text about the item itself, the image localization system may classify the text on the cereal box as DNT text, and may classify the embedded text about the item as TBT text based on identification that the text on the cereal box is located on an item. As another example, an infographic image may include a certification symbol, such as a “USDA organic certification.” The image localization system may classify the text within the certification symbol, “USDA organic” as DNT to help maintain fidelity of the certification symbol.

In some embodiments, the image localization system may group the TBT text into semantic groups. For example, the list of bounding boxes may identify single lines of text. In some cases, however, a sentence or group of sentences may extend to multiple lines of text, such that translation of individual lines may fail to properly capture sentence structure or context. Accordingly, the image localization system may analyze the TBT text to identify related lines of text. In some embodiments, the image localization system may predict a visual segmentation for the image to generate candidate groups of related lines in the same visual segment. In some cases, the image localization system may utilize a machine learning model, such as a Large Language Model (LLM), to split candidate text groups into sub-groups, such that each sub-group corresponds to a single sentence or paragraph.

The image localization system may use a translation engine to translate the TBT text. In some embodiments, the translation engine may include an LLM. In some cases, the LLM may be specially trained based on text from catalog or item images, which is often short and ungrammatical.

In some embodiments, the image localization system can remove the original text from the image. For example, the image localization system may use image inpainting to fill in masked-out regions with color and texture that match the semantics and appearance of the surrounding regions. For example, if the infographic image includes white TBT text on a blue background, the image localization system may identify a bounding box associated with the white TBT text and may fill in the bounding box with a matching blue to the background, such that the white TBT text is removed or covered.

In some embodiments, the image localization system may adjust or modify the image layout based on the translated text. For example, image localization system may identify the original font properties of the untranslated text and may compute any layout adjustments to fit the translated text into the image. For instance, if the translated text is longer than the original untranslated text, the image localization system may increase the size of an associated textbox to fit the translated text while maintaining the original font properties (e.g., font size, font type, font alignment, etc.). The image localization system can then render the image with the TBT text translated and the DNT text untranslated.

Various aspects of the disclosure will be described with regard to certain examples and embodiments, which are intended to illustrate but not limit the disclosure. Although aspects of some embodiments described in the disclosure will focus, for the purpose of illustration, on particular examples of item or catalog image localization, the examples are illustrative only and are not intended to be limiting. In some embodiments, the techniques described herein may be applied to additional or alternative types of images. Additionally, any feature used in any embodiment described herein may be used in any combination with any other feature or in any other embodiment, without limitation.

### Example Image Localization

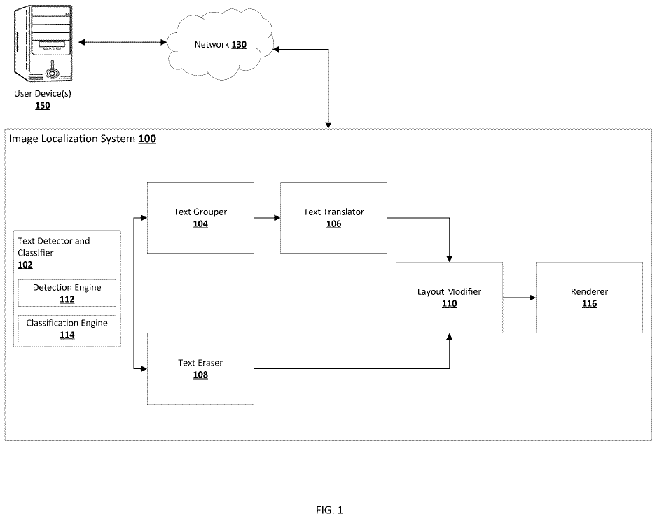

With reference to an illustrative example, FIG. 1 shows an example computing environment in which features of the present disclosure may be implemented. As shown, the computing environment includes one or more user devices 150, a network 130, and an image localization system 100. The one or more user devices 150 and the image localization system 100 may communicate with each other via a communication network 130, such as an intranet or the internet.

As shown, the image localization system 100 includes a text detector and classifier 102, a text grouper 104, a text translator 106, a text eraser 108, a layout modifier 110, and a renderer 116. In some embodiments, the image localization system 100 may include more or less components and/or one or more components of the image localization system 100 may be combined.

User device(s) 150 may be any of a wide variety of computing devices, including server computing devices, personal computing devices, terminal computing devices, laptop computing devices, tablet computing devices, mobile devices (e.g., smart phones, media players, handheld gaming devices, etc.), and various other electronic devices and appliances. A user device 150 may be used to provide to the image localization system 100 requests for an image to be localized for an image supplied by the client device 150 or otherwise available to the image localization system 100.

The image localization system 100 may be implemented on one or more physical server computing devices that provide image localization services to user device(s) 150. In some embodiments, the image localization system 100 (or individual components thereof) are implemented on one or more host devices, such as blade servers, midrange computing devices, mainframe computers, desktop computers, or any other computing device configured to provide computing services and resources. For example, a single host device may execute one or more components of the image localization system 100. The image localization system 100 may include any number of such hosts. FIG. 4 illustrates an example computing device that may be used.

In some embodiments, the features and services provided by the image localization system 100 are implemented as web services consumable via communication network. In further embodiments, the image localization system 100 (or individual components thereof) is provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment.

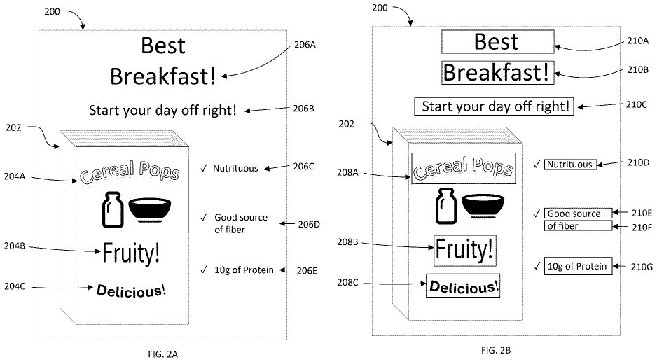

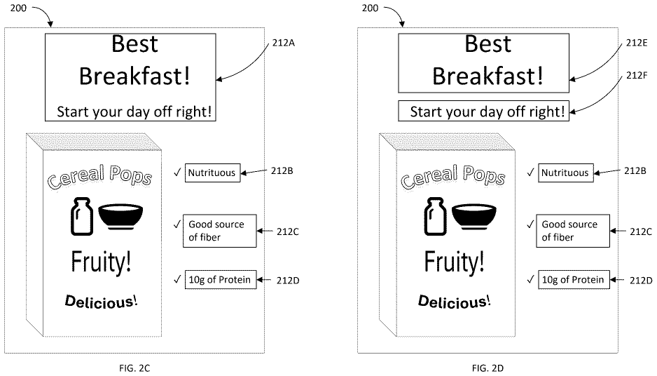

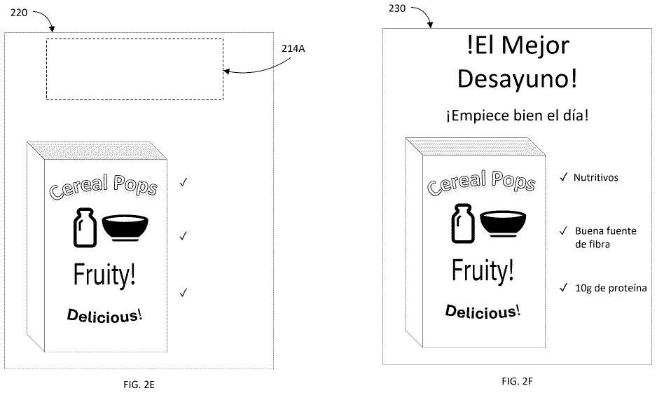

The image localization system 100 can obtain an image for localization, such as an item or catalog image. For example, FIG. 2A illustrates an example item image 200. FIG. 2A includes an item shot 202 of a cereal box, including item text 204A (“Cereal Pops”), 204B (“Fruity!”), and 204C (“Delicious!”). Additionally, FIG. 2A includes embedded text items 206A (“Best Breakfast”), 206B (“Start your day off right!”), 206C (“Nutritious”), 206D (“Good Source of Fiber”), 206E (“10 g of Protein”). The image localization system 100 can provide the image, such as the item image 200, to the text detector and classifier 102 for text detection and classification.

The text detector and classifier 102 can detect and classify text within an image as text-to-be translated (TBT text). In some embodiments, the text detector and classifier 102 can include a text detection engine 112 and a classification engine 114. The text detection engine 112 can detect text within an image. In some embodiments, the text detection engine 112 can use an OCR module, such as AMAZON REKOGNITION, to extract all text within an image. In some embodiments, the text detection engine 112 may use a machine learning model, such as an LLM, to detect and extract text within an image. In some embodiments, the text detection engine 112 can additionally identify a list of bounding boxes along with the associated text. For example, FIG. 2B illustrates an example annotated item image 200. FIG. 2B, illustrates bounding boxes 208A-208C that surround the item text 204A-204C and bounding boxes 210A-210G that surround the lines of the embedded text items 206A-206E. In some embodiments, the text detection engine 112 may detect single or multiple lines of text.

The classification engine 114 can classify text within an image as TBT text or DNT text. In some embodiments, the classification engine 114 can be trained to identify which text is or is not a part of, or associated with, graphical icons, brand logos, item packaging, and/or official certifications. In some embodiments, the classification engine 114 can include a multi-modal machine learning model (e.g., a multi-modal classifier) that combines visual and textual features for text detected by the text detection engine 112. In some embodiments, the classification engine 114 can extract a set of image features, such as by using a vision transformer (ViT). The ViT may be trained on a set of similar images, such as other item or catalog images, or infographic images. In some embodiments, the training data set for the ViT may include hundreds, thousands, or millions of manually or automatically annotated images. In some embodiments, the classification engine 114 can extract a visual feature associated with one or more of the bounding boxes identified by the text detection engine 112. For example, the classification engine 114 may use the bounding boxes as region proposals and apply a RoI-align (Region-of-Interest-align) operation to extract one or more visual feature vectors. Additionally, the classification engine 114 may use a language model, such as an LLM, or a deep learning language model, to identify a text feature vector from the text associated with one or more of the bounding boxes identified by the text detection engine 112. In some embodiments, the classification engine 114 may include a multi-portion machine learning model, such that a first portion comprises a ViT and a second portion comprises a language model (e.g., an LLM or a deep learning language model). In some embodiments, the classification engine 114 can concatenate the visual feature vectors and the text feature vectors for one or more bounding boxes or lines or text to classify the text as TBT text or DNT text.

In some embodiments, a machine learning model, such as an LLM, may be used to perform both the detection and classification steps simultaneously. For example, a machine learning model may take as input an item image, may be prompted to detect and classify text within the image, and may output bounding boxes identifying regions of text and associated classifications as TBT text or DNT text. In some embodiments, the text detector and classifier 102 may perform classification operations prior to performing text detection operations. For example, the text detector and classifier 102 may classify certain regions of an item image as containing TBT text and certain regions of an item image as containing DNT tex. Further, the text detector and classifier 102 may detect lines of text in the regions classified as containing TBT text, or in both regions classified as containing TBT text and regions classified as containing DNT text.

In some embodiments, a machine learning model, such as an LLM may be used to perform some or all of the operations of the image localization system 100 in a single operation. For example, a machine learning model could be prompted to localize an item image by translating embedded text without translating product associated text and may provide a localized item image as an output.

Returning to FIG. 2B, the classification engine 114 may classify the text associated with the bounding boxes 210A-210G as TBT text, as the text is not part of any graphical icons, brand logos, item packaging, and/or official certifications. Additionally, the classification engine 114 may classify the text associated with the bounding boxes 208A 208C as DNT text as the text is part of the item packaging of the cereal box illustrated by the item shot 202. In some embodiments, the text detector and classifier 102 can provide the TBT text and associated bounding boxes to the text grouper 104 and/or the text eraser 108.

The text grouper 104 can group lines of semantically related text. For example, the text detection engine 112 may identify individual lines of text, such as the lines identified by the bounding boxes 210A and 210B. However, sometimes these lines of text may be part of the same sentence or paragraph, such that translating them separately could result in sub-optimal translation due to a loss of context of the entire sentence or paragraph. Accordingly, the text grouper 104 can identify and group semantically related lines of text ahead of translation. In some embodiments, the text grouper 104 can project a visual segmentation map on the image that groups semantically related lines in the same visual segment. For example, FIG. 2C illustrates an example visual segmentation map overlayed on the item image 200. The visual segmentation map includes four segments, segments 212A-212D.

As illustrated, in some cases, the visual segmentation map may over-group text, such that multiple sentences are combined in a single segment rather than being separated. Accordingly, in some embodiments, the text grouper 104 may treat one or more segments as candidate segments and may input the candidate segments into a trained LLM to split one or more candidate segments into sub-segments, such that each sub-segment identifies a single sentence. For example, FIG. 2D illustrates an example output of the LLM, such that segment 212A is split into segments 212E and 212F. In some embodiments, the LLM may be trained to identify sub-segments representing single paragraphs. In some embodiments, the LLM may be trained using hundreds or thousands of similar images, such as annotated item or catalog images. For example, the text grouper 104 may add outputs of the LLM to the training data for additional training or updating of the model. In some embodiments, the text grouper 104 can provide the identified segments to the text translator 106 for text translation.

The text translator 106 can translate identified TBT text. In some embodiments, the text translator 106 includes a machine learning model, such as an LLM or other language model. The machine learning model can take as input, the text associated with one or more of the segments identified by the text grouper 104. In some embodiments, the machine learning model may be trained on text associated with item images, which can differ from typical datasets for training text translation models. For example, typical datasets for training text translation models may include full sentences or paragraphs of text. However, text associated with item images can be short and ungrammatical, such that alternative training datasets specific to typical item images can improve translation of text associated with item or catalog images. In some embodiments, the text translator 106 may include multiple machine learning models trained between specific languages (e.g., English to Spanish). In some embodiments, the text translator 106 may include a single or multiple machine learning models trained to translate between multiple languages (e.g., English to Spanish or French, or English or Spanish to French). The text translator 106 may identify which machine learning model to use based on a provided localization identifier (e.g., a language or country or region designation). In some embodiments, the text translator 106 can provide the translated text to the layout modifier 110 for image layout modification based on the translated text. In some embodiments, the text translator 106 may translate sentences or phrases individually. In some embodiments, the text translator 106 may translate all TBT text simultaneously. For example, the text translator 106 may input all TBT text into a machine learning model for translation.

The text eraser 108 can erase original lines of text from an image to generate a “empty image” (e.g., an image in which the TBT text has been removed). This can enable rendering of the empty image with translated text. In some embodiments, the text eraser 108 may utilize image inpainting to fill in masked-out regions with color and texture that match the semantics and appearance of the surrounding regions. For example, FIG. 2E illustrates an example of an empty image 220 generated through text erasing of the item image 200. FIG. 2E illustrates the empty image 220 corresponding to the item image 200 with the embedded text items 206A-206E removed. For illustrative purposes, FIG. 2E includes mask region 214A corresponding to the segment 212E in which the bounding box associated with the 212E has been filled in with the same color as the background. Although illustrated with a single-color background, the text eraser 108 can erase text for images with more complex backgrounds such as gradient backgrounds, pattern backgrounds, or image backgrounds. In some embodiments, the masked-out regions may correspond to text strokes of the TBT text, such that just the text strokes are erased rather than a block (or other shape) around the text.

In some embodiments, the text eraser 108 can include a machine learning model for erasing text from an image. In some embodiments, the machine learning model may be trained on hundreds or thousands of sets of images, such as item or catalog images. A particular set may include an image with embedded text and the same image with the embedded text removed. In some cases, the training data may be manually or automatically generated. For example, the text eraser 108 may add outputs of the machine learning model to the training data for additional training or updating of the model. The training data can include images with simple and/or complex backgrounds. In some embodiments, the text eraser 108 includes a background classifier. The background classifier can label image regions as simple or complex. In some embodiments, the label may be used as an input for the machine learning model used to erase text from the image. In some embodiments, the background classifier may be a machine learning model. In some embodiments, the background classifier may be a portion of the machine learning model used to erase text from the image. In some embodiments, the text eraser 108 can provide the empty image to the layout modifier 110 for layout updating.

In some embodiments, the text translator 106 can provide the translated text to the text eraser 108 in addition to, or alternatively to, the layout modifier 110. For example, in some embodiments, the text translator 106 may identify that all or a portion of the TBT text does not need to be translated, such as because the same word is used in both the original language and the translated language, or because the text translator 106 identifies a brand name or other term that was misclassified by the classification engine 114 as TBT text. Accordingly, in some cases, the text eraser 108 may determine not to erase text that was not translated by the text translator 106, despite the text being classified as TBT text by the classification engine 114.

The layout modifier 110 can modify the layout of an “empty image” (an image in which the TBT text has been erased) in preparation for rendering of the image with translated text. The layout modifier 110 can modify the layout such that the visual appearance of the original image is maintained (e.g., font sizes, font types, and/or text alignment is maintained). In some embodiments, the layout modifier 110 may identify font properties of the original text and adapt the layout of the image to fit the translated text, such as by expanding or reducing textbox dimensions, while also maintaining text alignment and preventing text items from overlapping with each other or other image elements.

In some embodiments, the layout modifier 110 can include a machine learning model, such as a ResNet (residual network) model, to predict font attributes such as font family, style (bold, italic, underline, etc.), and/or color of text, from the original image. The model may identify font attributes for individual text boxes, such as the segments 212B-212F. In some embodiments, the machine learning model may be trained on a synthetic dataset of hundreds or thousands of images, which may include a variety of font families, styles, and colors. The dataset may be generated by rendering random text strings at randomly sampled angles, font colors, styles and sizes on item or catalog images.

In some embodiments, the layout modifier 110 can predict text alignment and bounding box offsets to determine how to best expand or shrink original text boxes to optimally accommodate translated text, based on the predicted font attributes. For example, the layout modifier 110 may use a trained machine learning model, such as a model with a ViT backbone and an MLP head to predict bounding box offsets. In some cases, the model, such as via the ViT backbone, can obtain visual features of the original text boxes. Visual features may include the shape, dimensions, coordinates, text alignment, or other features of the original text boxes. In some embodiments, the model may take as input, multiple masks that indicate a stretch or expansion of a given textbox in high or width if surrounding elements and image context are disregarded. In some embodiments, the visual features as well as the textbox expansion parameters may be concatenated and used as input, such as input for a MLP head, to predict bounding box offsets. Based on the predicted offsets, the layout modifier 110 can adjust the text boxes as indicated by the model. For example, the illustrated text associated with the segment 212D is “10 g of protein” in English and “10 g de proteína” in Spanish. As the Spanish text is longer than the English text, the layout modifier 110 may lengthen the bounding box associated with the segment 212D to accommodate the longer translated text. In some embodiments, the layout modifier 110 can provide the modified empty image to the renderer 116 for image rendering.

In some embodiments, the layout modifier 110 determines not to modify the layout of the empty image, such as if the translated text already fits in the existing layout. In some embodiments, the layout modifier 110 may determine to modify the text itself rather than a text box. For instance, the layout modifier 110 may update a font size of a text item rather than updating the size of an associated text box.

The renderer 116 can render a localized image. For example, the renderer 116 can superimpose the translated text in the modified empty image to render a localized image. With reference to an illustrative example, FIG. 2F illustrates a rendered image 230 corresponding to the item image 200 with the embedded text translated from English to Spanish. In the illustrated example, the embedded text has been translated, while the item text has not been translated.

### Example Image Localization Routine

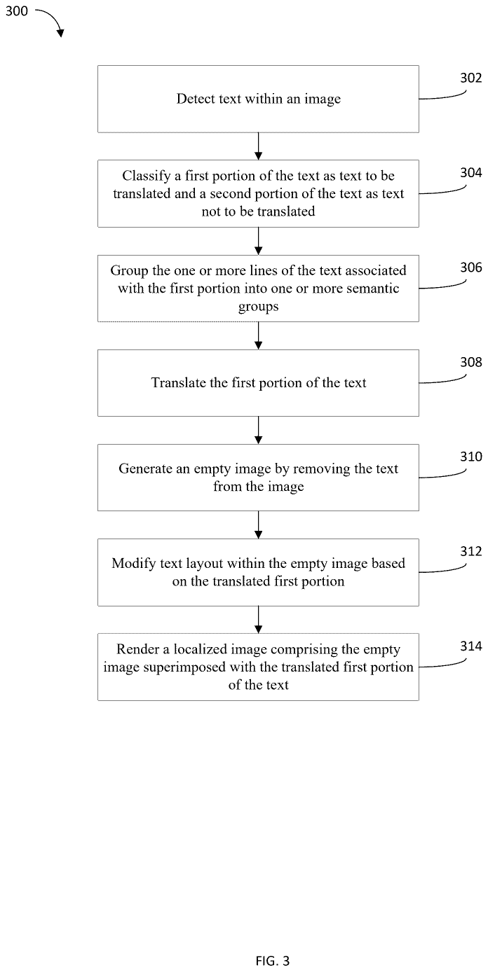

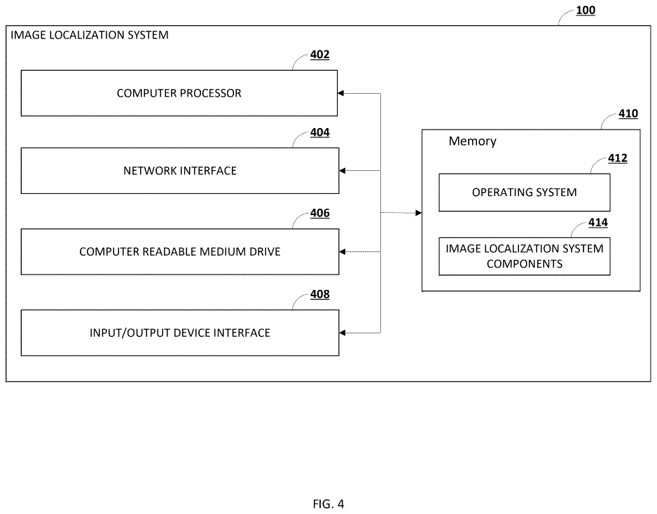

FIG. 3 illustrates an example routine 300 for localizing images, such as item or catalog images. The routine 300 begins at block 302. The routine 300 may begin in response to an event, such as receipt by an image localization system of a request to localize an image. For example, a user device, such as user device 150, may submit a request including or referencing an image to be localized (e.g., by file name, network address, or another identifier). The request may further include or reference the target language, country, and/or region to which text in the image is to be localized (e.g., by language name, identifier, etc.).

When the routine 300 is initiated, a set of executable program instructions stored on one or more non-transitory computer-readable media (e.g., hard drive, flash memory, removable media, etc.) may be loaded into memory (e.g., random access memory or RAM) of an image localization system, such as the image localization system 100 shown in FIG. 4, and executed by one or more processors. In some embodiments, the routine 300 or portions thereof may be implemented on multiple processors, serially or in parallel.

At block 302, the image localization system 100 can detect text (e.g., embedded text and/or product associated text) within an image. For example, the image localization system 100 may perform operations as described herein with respect to FIGS. 1 and 2B. For example, the text detection engine 112 may identify one or more bounding boxes associated with one or more lines of the text using OCR on the image or portions thereof.

At block 304, the image localization system 100 can classify a first portion of the text as text to be translated and a second portion of the text as text not to be translated. For example, the image localization system 100 may perform operations as described herein with respect to FIGS. 1 and 2B. For example, for at least one bounding box, the classification engine 114 can extract a visual feature vector associated from the at least one bounding box and extract a text feature vector from the associated text. The classification engine 114 can concatenate the visual feature vector and the text feature vector and use the concatenated vector to classify portions of the text as TBT text or DNT text. In some embodiments, the second portion of the text may be part of a graphical icon, brand logo, item packaging, and/or an official certification.

In some embodiments, the image localization system 100 may classify all of the text as TBT text. For example, the image localization system 100 may identify that none of the text in an image is a part of a graphical icon, brand logo, item packaging, and/or official certification. In some embodiments, the image localization system 100 may classify none of the text as DNT text. For example, the image localization system 100 may identify that all of the text in an image is part of a graphical icon, brand logo, item packaging, and/or official certification.

At block 306, the image localization system 100 can group one or more lines of the text associated with the first portion into one or more semantic groups. For example, the image localization system 100 may perform operations as described herein with respect to FIGS. 1, 2C, and 2D. For example, the text grouper 104 can project a visual segmentation map onto the image. The visual segmentation map can identify one or more groups of semantically related lines of text (e.g., lines of text associated with the same sentence). In some cases, the text grouper 104 can identify that a particular group includes multiple sentences and can split the particular group into one or more subgroups, such that each subgroup comprises an individual sentence.

At block 308, the image localization system 100 can translate the first portion of the text based on the one or more semantic groups. For example, the image localization system 100 may perform operations as described herein with respect to FIG. 1 and the text translator 106. For example, the text translator 106 can individually translate the text associated with the one or more semantic groups from a first language (e.g., English) to a second language (e.g., Spanish).

At block 310, the image localization system 100 can generate an empty image by removing the text from the image. For example, the image localization system 100 may perform operations as described herein with respect to FIGS. 1 and 2E. For example, the text eraser 108 can identify visual segments associated with the first portion of the text (e.g., the TBT text). The text eraser 108 can identify a color and/or texture of a region surrounding the visual segment. And the text eraser 108 can fill in the visual segment with the color and texture of the region surrounding the visual segment.

At block 312, the image localization system 100 can modify the text layout within the empty image based on the translated first portion of the text. For example, the image localization system 400 may perform operations as described herein with respect to FIG. 1 and the layout modifier 110. For example, for at least one of the text boxes associated with the first portion of the text, the layout modifier 110 can predict a set of font attributes associated with the text box. Additionally, the layout modifier 110 can predict a bounding box offset associated with the text box based on the set of font attributes and the translated text associated with the text box. Further, the layout modifier 110 can update or adjust a dimension (e.g., height or width) of the text box based on the predicted bounding box offset.

At block 314, the image localization system 100 can render a localized image comprising the empty image superimposed with the translated first portion of the text. For example, the image localization system 100 may perform operations as described herein with respect to FIGS. 1 and 2F. For example, the renderer 116 can superimpose the translated text on the modified empty image to render a localized image, such as the rendered image 230.

### Execution Environment

FIG. 4 illustrates various components of the example image localization system 100 of FIG. 1 configured to implement various functionality described herein.

In some embodiments, the image localization system 100 is implemented using any of a variety of computing devices, such as server computing devices, desktop computing devices, personal computing devices, mobile computing devices, mainframe computing devices, midrange computing devices, host computing devices, or some combination thereof.

In some embodiments, the features provided by the image localization system 100 are implemented as web services consumable via one or more communication networks. In further embodiments, the image localization system 100 is provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment.

In some embodiments, as shown, the image localization system 100 includes: one or more computer processors 402, such as physical central processing units (“CPUs”); one or more network interfaces 404, such as a network interface cards (“NICs”); one or more computer readable medium drives 406, such as a high density disk (“HDDs”), solid state drives (“SSDs”), flash drives, and/or other persistent non-transitory computer readable media; one or more input/output device interfaces; one or more input/output device interfaces 408; and one or more computer-readable memories 410, such as random access memory (“RAM”) and/or other volatile non-transitory computer readable media.

The computer-readable memory 410 may include computer program instructions that one or more computer processors 402 execute and/or data that the one or more computer processors 402 use in order to implement one or more embodiments. For example, the computer-readable memory 410 can store an operating system 412 to provide general administration of the image localization system 100. As another example, the computer readable memory 410 can store image localization system component instructions 414 for various components for image localization, such as the text detector and classifier 102, the text grouper 104, the text translator 106, the text eraser 108, the layout modifier 110, and/or the text detection engine 112.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system is a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
at least one processor, and
at least one non-transitory storage media storing instructions that, when executed by the at least one processor, cause the at least one processor to:
detect text within an image, wherein the text comprises one or more lines of text, and wherein the text is in a first language;
identify one or more bounding boxes associated with the one or more lines of text within the image;
classify a first portion of the text as text to be translated and a second portion of the text as text not to be translated;
group the one or more lines of the text associated with the first portion of the text into one or more semantic groups;
translate, each of the one or more semantic groups of the first portion of the text, from the first language to a second language;
generate an empty image by removing the first portion of text from the image, wherein the empty image comprises the second portion of the text;
modify a text layout of at least one text box associated with the empty image based on the translated first portion of the text; and
render a localized image comprising the empty image superimposed with the translated first portion of the text.

2. The system of claim 1, wherein the second portion of the text is part of at least one of a graphical icon, brand logo, item packaging, or an official certification.

3. The system of claim 1, wherein to classify the first portion of the text as text to be translated and the second portion of the text as text not to be translated, the instructions, when executed by the at least one processor, further cause the at least one processor to:
for at least one bounding box of the one or more bounding boxes, extract a visual feature vector associated with the at least one bounding box and extract a text feature vector associated with a line of text associated with the at least one bounding box;
concatenate the visual feature vector and the text feature vector; and
classify the line of text associated with the at least one bounding box based on the concatenated visual feature vector and the text feature vector as either text to be translated or text not to be translated.

4. The system of claim 1, wherein to group the one or more lines of the text associated with the first portion into one or more semantic groups, the instructions, when executed by the at least one processor, further cause the at least one processor to:
project a visual segmentation map on the image, wherein the visual segmentation map identifies one or more groups of semantically related lines of text;
identify that a particular group of the one or more groups of semantically related lines comprises multiple sentences; and
split the particular group into one or more subgroups, wherein each subgroup comprises an individual sentence.

5. A computer-implemented method, comprising:
identifying one or more bounding boxes associated with one or more lines of text within an image;
classifying a first portion of the text as text to be translated and a second portion of the text as text not to be translated;
grouping one or more lines of the text associated with the first portion into one or more semantic groups;
generating an empty image by removing the first portion of text from the image;
translating the first portion of the text from a first language to a second language, based on the one or more semantic groups;
modifying a text layout within the empty image based on the translated first portion of the text; and
rendering a localized image comprising the empty image superimposed with the translated first portion of the text.

6. The computer-implemented method of claim 5, wherein the second portion of the text is part of at least one of a graphical icon, brand logo, item packaging, or an official certification.

7. The computer-implemented method of claim 5, wherein classifying a first portion of the text as text to be translated and a second portion of the text as text not to be translated comprises:
for at least one bounding box of the one or more bounding boxes, extracting a visual feature vector associated with the at least one bounding box and extracting a text feature vector associated with a line of text associated with the at least one bounding box;
concatenating the visual feature vector and the text feature vector; and
classifying the line of text associated with the at least one bounding box based on the concatenated visual feature vector and the text feature vector as either text to be translated or text not to be translated.

8. The computer-implemented method of claim 5, wherein grouping the one or more lines of the text associated with the first portion into one or more semantic groups comprises:
projecting a visual segmentation map on the image, wherein the visual segmentation map identifies one or more groups of semantically related lines of text;
identifying that a particular group of the one or more groups of semantically related lines comprises multiple sentences; and
splitting the particular group into one or more subgroups, wherein each subgroup comprises an individual sentence.

9. The computer-implemented method of claim 5, wherein generating an empty image comprises:
identifying a visual segment associated with the first portion of the text;
identifying a color and texture of a region surrounding the visual segment; and
filling the visual segment with the color and the texture of the region surrounding the visual segment.

10. The computer-implemented method of claim 5, wherein modifying the text layout within the empty image comprises:
predicting a set of font attributes associated with a text box associated with the first portion of the text;
predicting a bounding box offset associated with the text box based on the set of font attributes and translated text associated with the text box; and
updating a dimension of the text box based on the predicted bounding box offset.

11. A non-transitory storage media storing instructions that, when executed by at least one processor, cause the at least one processor to:
detect text within an image;
classify a first portion of the text as text to be translated and a second portion of the text as text not to be translated;
translate the first portion of the text; and
render the image with the second portion of the text and the translated first portion of the text.

12. The non-transitory storage media of claim 11, wherein the second portion of the text is part of at least one of a graphical icon, brand logo, item packaging, or an official certification.

13. The non-transitory storage media of claim 11, wherein to detect the text within the image, the instructions, when executed by the at least one processor, cause the at least one processor to identify one or more bounding boxes associated with one or more lines of the text.

14. The non-transitory storage media of claim 13, wherein to classify the first portion of the text as text to be translated and the second portion of the text as text not to be translated, the instructions, when executed by the at least one processor, cause the at least one processor to:
for at least one bounding box of the one or more bounding boxes, extract a visual feature vector associated with the at least one bounding box and extracting a text feature vector associated with a line of text associated with the at least one bounding box;
concatenate the visual feature vector and the text feature vector; and
classify the line of text associated with the at least one bounding box based on the concatenated visual feature vector and text feature vector as either text to be translated or text not to be translated.

15. The non-transitory storage media of claim 13, wherein the instructions, when executed by the at least one processor, further cause the at least one processor to group the one or more lines of the text associated with the first portion into one or more semantic groups.

16. The non-transitory storage media of claim 15, wherein to group the one or more lines of the text associated with the first portion into one or more semantic groups, the instructions, when executed by the at least one processor, cause the at least one processor to:
project a visual segmentation map on the image, wherein the visual segmentation map identifies one or more groups of semantically related lines of text;
identify that a particular group of the one or more groups of semantically related lines comprises multiple sentences; and
split the particular group into one or more subgroups, wherein each subgroup comprises an individual sentence.

17. The non-transitory storage media of claim 11, wherein the instructions, when executed by the at least one processor, further cause the at least one processor to:
generate an empty image by removing the first portion of text from the image; and
modify a text layout within the empty image based on the translated first portion of the text.

18. The non-transitory storage media of claim 17, wherein to generate an empty image the instructions, when executed by the at least one processor, further cause the at least one processor to:
identify a visual segment associated with the first portion of the text;
identify a color and texture of a region surrounding the visual segment; and
fill the visual segment with the color and the texture of the region surrounding the visual segment.

19. The non-transitory storage media of claim 17, wherein to modify the text layout within the empty image based on the translated first portion the instructions, when executed by the at least one processor, further cause the at least one processor to:
predict a set of font attributes associated with a text box associated with the first portion of the text;
predict a bounding box offset associated with the text box based on the set of font attributes and translated text associated with the text box; and
update a dimension of the text box based on the predicted bounding box offset.

20. The non-transitory storage media of claim 19, wherein the set of font attributes comprises at least one of: text alignment, font family, font style, or font color.
